(19) United States
(12) Patent Application Publication
(10) Pub. No.: US 2025/0240562 A1
(43) Pub. Date: Jul. 24, 2025

(54) Low Latency Stereo Analog Digital MEMS Microphone for Audio Live Performance and Multi-Track Recording

(71) Applicant: Michael Dean Garvey, Wofford Heights, CA (US)

(72) Inventor: Michael Dean Garvey, Wofford Heights, CA (US)

(21) Appl. No.: 18/418,313

(22) Filed: Jan. 21, 2024

(51) Int. Cl. H04R 3/00

(52) U.S. Cl. CPC H04R 3/005; H04R 2201/003

(57) ABSTRACT

The Low Latency Stereo Analog Digital MEMS Microphones for Audio Live Performance and Multi-Track Recording (i.e. the Invention) takes serial audio digital data from one (mono) or two (stereo) MEMS microphones and sends the data directly to a mono or stereo digital-to-analog converter (thereby eliminating processing latency in a original and unique design implementation) which generates an analog line voltage signal for use by commercially available audio amplifiers and recording devices.

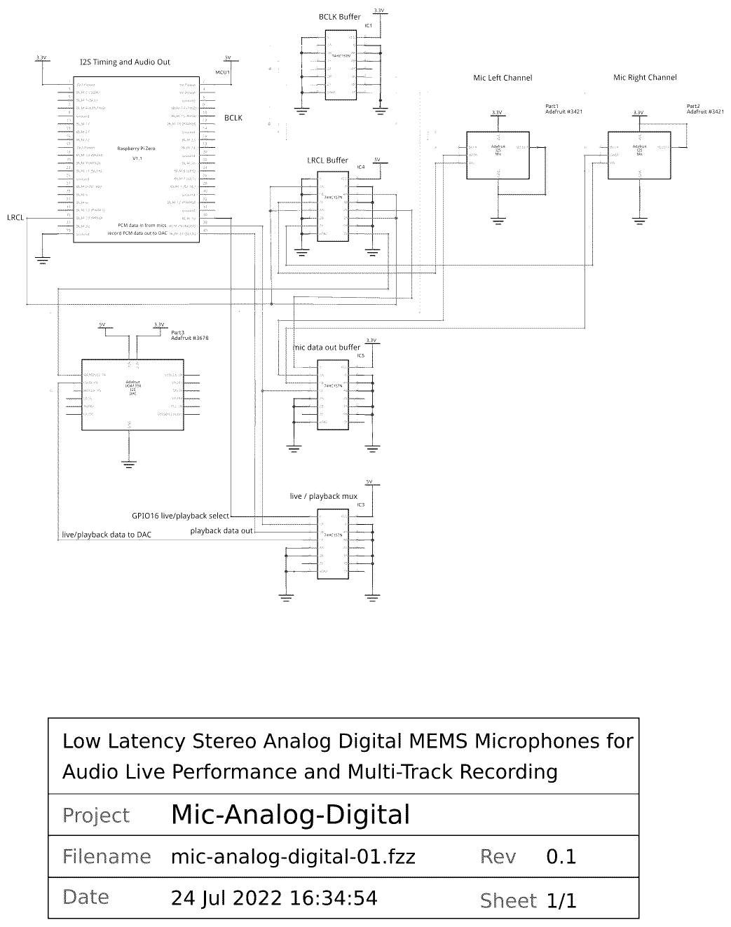

### BACKGROUND OF THE INVENTION

The Inventor is a retired electrical engineer who specialized in audio/acoustics hardware and software.

Recently, the Inventor has been writing music and was fortunate to have two songs picked up by a small record company.

While recording music from an acoustic guitar, the Inventor decided to experiment with MEMS microphones that the Inventor had previously used for audio security equipment design since they are physically small, have excellent audio characteristics, and can easily be placed inside the sound box of an acoustic guitar or other musical instrument (e.g. violin).

Since audio latency is a critical issue in audio live performance and multi-track recording, the Inventor looked for a method to bypass a processor and connect a MEMS microphone directly to a digital-to-analog converter.

Based upon prior experience with small ARM embedded Linux processors, the Inventor was aware that some Raspberry Pi models, and other small ARM processors, create the required timing signals to receive serial audio data via the I2S interface from MEMS microphones and to transmit serial audio data via the I2S interface to digital-to-analog converters, so the Inventor designed and built an original and unique functional prototype using the commercially available electronic components shown in the drawing.

### BRIEF SUMMARY OF THE INVENTION

The Low Latency Stereo Analog Digital MEMS Microphones for Audio Live Performance and Multi-Track Recording takes serial audio data from one (mono) or two (stereo) MEMS microphones and sends it directly to a mono or stereo digital-to-analog converter which can be used by commercially available audio amplifiers and recording devices in the invention's unique method.

### BRIEF DESCRIPTION OF THE DRAWING

The I2S Timing and Audio Out component is a small and inexpensive commercially available ARM processor that creates I2S timing signals for the purpose of inputting mono or stereo serial audio data into the processor and outputting manipulated mono or stereo serial audio data to a device such as an digital-to-audio converter. This invention uses the I2S timing signals only, and therefore eliminates the need to route the serial audio data into and out of the processor, thereby eliminating latency cause by processing.

The Mic Left Channel and Mic Right Channel are small and inexpensive commercially available MEMS microphones that output serial audio data that conform to the I2S timing signals.

The BCLK Buffer, LRCL Buffer, and mic data output buffer are commercially available data signal buffers to allow 0.3 meter (12 inch) length wiring for the two MEMS microphones in the invention prototype since the BCLK signal operates at 2 MHz.

Part 3 Adafruit #3678 is a stereo digital-to-analog converter that uses the I2S timing signals and receives the serial audio data from the two MEMS microphones to create a standard analog line voltage that is used in commercial audio amplifiers and recording devices.

The live/playback mux was used for development to measure the latency of the Mic Left Channel and Mic Right Channel routed to the Part 3 Adafruit #3678 digital-to-analog converter as compared to routing the Mic Left Channel and Mic Right Channel into the I2S Timing and Audio Out (i.e. the processor), processing the audio data with software, and then routing the processed serial audio data to the Part 3 Adafruit #3678 digital-to-analog converter.

The live/playback mux is unique feature of this invention since it can be controlled by software to route the serial audio data from the Mic Left Channel and Mic Right Channel directly to the Part 3 Adafruit #3678 digital-to-analog converter, thereby bypassing the standard method of routing serial audio data into, and out of, a processor.

### DETAILED DESCRIPTION OF THE INVENTION

MEMS microphones are in use in most modern cell phones and other applications where audio sound pressure is converted into a serial stream of digital data for use by a processor.

The Low Latency Stereo Analog Digital MEMS Microphones for Audio Live Performance and Multi-Track Recording uses an audio sample rate of 32,000 samples per second, with a resolution of 18 bits per sample. The MEMS microphone employed has a bandwidth of 50 Hz to 15 kHz, +/−3 dB, with a dynamic range of 104 dB.

The speed of sound through dry air at room temperature (25 C) is approximately 346 meters/second, which means that sound travels about 28.9 cm every second (or slightly less that one foot every second). For the purpose of this discussion, we will define acoustical distance as the distance from a sound source to a sound listening device (e.g. a microphone or a person's ears).

This is important because some people can detect an audio latency of less than 1 mSec (https://ieeexplore.ieee.org/document/9450008), and many musicians find that an audio latency of 8 mSec or more is problematic (https://olehch.medium.com/a-comprehensive-guide-to-audio-latency-in-cubase-161d4145631c). 8 mSec can be described as an acoustic distance of about 2.4 meters (8 feet).

At 32,000 samples per second, each new sample is spaced 0.03125 mSec from the prior sample. When this serial audio data is input to a processor, however, the time required to manipulate the audio data (e.g. apply an algorithm to change frequency response or mix multiple audio inputs together) typically requires much more time that 8 mSec, creating a noticeable, and undesirable, latency.

The MEMS microphone (used in this invention) employs the Inter-IC Sound (I2S) protocol that was developed by Phillips Semiconductor (now NXP Semiconductors) in 1986 (https://www.nxp.com/docs/en/user-manual/UM11732.pdf).

The Low Latency Stereo Analog Digital MEMS Microphones for Audio Live Performance and Multi-Track Recording bypasses the processor by routing the digital audio serial stream output from one (mono) or two (stereo) MEMS microphone(s) directly into the mono or stereo digital-to-analog converter that creates a standard analog line voltage for use in common audio amplifiers and recording devices.

This invention employs a non-standard, and apparently non-published, method of use for of one (mono) or two (stereo) MEMS microphones to mono or stereo digital-to-analog converter pathway that reduces the audio latency to such a low level that this invention has a very high utility for live audio performances and multi-track recording applications.

The time required to transfer one sample of audio data from the MEMS microphone output to the digital-to-analog converter input is the inverse of the sample rate ( 1/32, 000=0.03125 mSec).

The latency time from the acoustic pressure arriving at the MEMS microphone to the corresponding voltage appearing at the output of the digital-to-analog converter is equal to the analog-to-digital conversion time of the MEMS microphone plus the data transfer time (0.03125 mSec) plus the digital-to-analog conversion time, which has been measured to be less than 0.1 mSec. This is an acoustic distance of less than 2 inches, which is reportedly imperceptible to a musician, making the Low Latency Stereo Analog Digital MEMS Microphones for Audio Live Performance and Multi-Track Recording both useful and desirable for live performances and multi-track recording.

The result is a physically small and inexpensive mono or stereo microphone that can be placed on or inside musical instruments which produces very high musical sound quality and interfaces to industry standard audio amplifiers. The mono or stereo microphone can also be attached to performer headsets for vocalists.

1. The unique method of directly connecting the serial data output from a single MEMS microphone to a single channel (i.e. mono) digital-to-analog converter is an invention based upon a unique and previously unknown utilization of commercially available components, resulting in a low latency mono microphone system for audio live performance and multi-track recording.

2. The unique method of directly connecting the serial data output from two MEMS microphones to a two channel (i.e. stereo) digital-to-analog converter is an invention based upon a unique and previously unknown utilization of commercially available components, resulting in a low latency stereo microphone system for audio live performance and multi-track recording.

3. The use of the I2S timing signals from commercially available processors to implement claim 1 and/or claim 2, including the software controlled live/playback mux, is an invention based upon a unique and previously unknown utilization of commercially available components, resulting in a low latency mono or stereo microphone system for audio live performance and multi-track recording or a standard implementation of routing serial audio data into, and out of, a processor.
